(19) United States
(12) Patent Application Publication
(10) Pub. No.: US 2017/0287012 A1
(43) Pub. Date: Oct. 5, 2017

(54) Application Customization Based on User Data

(71) Applicant: Criteo, SA, Paris (FR)

(72) Inventors: Eric Le Barz, Paris (FR); Jason Morse, Seattle, WA (US)

(21) Appl. No.: 15/087,737

(22) Filed: Mar. 31, 2016

(51) Int. Cl. G06Q 30/02

(52) U.S. Cl. CPC G06Q 30/0269

(57) ABSTRACT

Described are methods, systems, and apparatus for customizing applications based on user behavior data. User behavior data is collected and stored by an ad system based on a user's interactions. The user behavior data is associated with an ad system user ID. A request for first user customization data including an application user ID associated with a user device is sent by an application executing on a user device. The ad system user ID associated with the application user ID is determined by the ad system. User customization data is determined by the ad system based on the user behavior data stored by the ad system as associated with the ad system user ID. The user customization data is sent to the user device. A customization based on the user customization data is implemented by the application executing on the user device.

### FIELD OF THE TECHNOLOGY

The present technology relates generally to application customization and, more specifically, to application customization based on cross-device user behavioral data.

### BACKGROUND

Many ad systems collect data based on users' interactions with websites. The data can be used to better understand the users' preferences and improve the user's experience online. In some ad systems, the data is associated with an identifier unique to the ad system. Many mobile devices can utilize a different identifier, which is associated with the device. For example, IOS devices can utilize an Identifier for Advertisers (“IDFA”) or ANDROID devices can utilize an Advertising ID. The data collected by the ad systems is often not used to customize applications for mobile devices because the data is not associated with the identifiers used by the mobile devices. Accordingly, the application are not customized in a manner to improve the users' experience.

### SUMMARY OF THE TECHNOLOGY

Accordingly, there is a need for technology to facilitate the customization of applications based on user behavior data collected based on the multiple user devices' interactions with websites. In one aspect, there is a method performed by a computing system. The method includes collecting and storing, by an ad system, user behavior data based on a user's interactions. The method includes associating, by the ad system, the user behavior data with an ad system user ID. The method includes sending, by a first application executing on a user device, a first request for first user customization data, the first request including an application user ID associated with the user device. The method includes receiving, by the ad system, the first request for the first user customization data. The method includes determining, by the ad system, the ad system user ID is associated with the application user ID. The method includes determining, by the ad system, the first user customization data based on the user behavior data stored by the ad system as associated with the ad system user ID. The method includes sending, by the ad system, to the user device, the first user customization data. The method includes implementing, by the first application executing on the user device, a first customization based on the first user customization data.

In some embodiments, the first customization includes the first application displaying content indicated by the first user customization data. In some embodiments, the first application is associated with a merchant and the first customization includes the first application displaying one or more of the merchant's products indicated by the first user customization data. In some embodiments, implementing the first customization, by the first application executing on the user device, includes causing the first application to deep-link as specified in the first user customization data. In some embodiments, the first customization includes configuring the first application based on the first user customization data. In some embodiments, the ad system user ID is the same as the application user ID. In some embodiments, the user's interactions include the user's browsing interactions with one or more websites. In some embodiments, the user's interactions include the user's interactions with one or more applications.

In another aspect, there is a method performed by a computing system. The method includes receiving, by a user device, a first ad for a first application. The method includes displaying, by the user device, the first ad for the first application. The method includes sending, by the user device, to the ad system, a first request for the first application in response to a user interaction with the first ad. The method includes sending, by the ad system, first user customization data to an ad attribution system. The method includes redirecting, by the ad attribution system, the user device to an application server. The method includes receiving, by the user device, from the application server, a first application installation package for the first application, the first application installation package including first customization request instructions. The method includes processing, by the user device, the first application installation package to install the first application. The method includes executing, by the user device, the first customization request instructions to send a second request for first user customization data, the second request including the application user ID associated with the user device. The method includes receiving, by the ad attribution system, the second request for the first user customization data. The method includes determining, by the ad attribution system, an ad attribution system user ID associated with the application user ID. The method includes determining, by the ad attribution system, the first user customization data based on the ad attribution system user ID. The method includes sending, by the ad attribution system, to the user device, the first user customization data. The method includes executing, by the user device, the first application. The method includes implementing, by the first application, a first customization based on the first user customization data.

In some embodiments, the method can include determining, by the user device, that the first application is not installed on the user device prior to sending the first request. In some embodiments, the first customization includes the first application displaying content indicated by the first user customization data. In some embodiments, the first application is associated with a merchant and the first customization includes the first application displaying one or more of the merchant's products indicated by the first user customization data. In some embodiments, implementing the first customization, by the first application, includes causing the first application to deep-link as specified in the first user customization data. In some embodiments, the first customization includes configuring the first application based on the first user customization data.

Other aspects and advantages of the present technology will become apparent from the following detailed description, taken in conjunction with the accompanying drawings, illustrating the principles of the technology by way of example only.

### BRIEF DESCRIPTION OF THE DRAWINGS

The foregoing and other objects, features, and advantages of the present technology, as well as the technology itself, will be more fully understood from the following description of various embodiments, when read together with the accompanying drawings, in which:

FIG. 1 is a diagram of a networked system in accordance with embodiments of the technology.

FIG. 2 depicts a flow chart of a method for customizing an application.

FIGS. 3A-3C depict a flow chart of a method for customizing an application at the time of installation.

### DETAILED DESCRIPTION

In some embodiments, the technology described herein can facilitate application customization based on cross-device user data. The technology can provide systems that facilitate identifying computing devices as associated with users for whom behavioral data has been collected in another context, such as the users' web browsing from another device. The technology can thereby allow customization of the applications running on the computing devices based on the information known about the user. In an exemplary application, an ad system can collect user behavior data based on a user's browsing interactions with one or more websites, such as viewing and purchasing history. The ad system can store the user behavior data as associated with an ad system user ID. An application executing on a device of the user can send a request to the ad system for user customization data. The application can include in the request an application user ID associated with the user's device, such as its IDFA or Android Advertising ID.

Beneficially, the technology can facilitate determining an ad system user ID so that the user behavior data can be used for customization of the application. The ad system can receive the request for the user customization data and determine an ad system user ID is associated with the application user ID. The ad system can determine user customization data based on the user behavior data stored by the ad system as associated with the ad system user ID. The ad system can then send the user device the user customization data. The application can then process the user customization data to provide an experience customized for the user. For example, the application can display customized content based on the customization data, deep-link into the application based on the user customization data, or configure the application for the user based on the user customization data.

### Environment and Systems

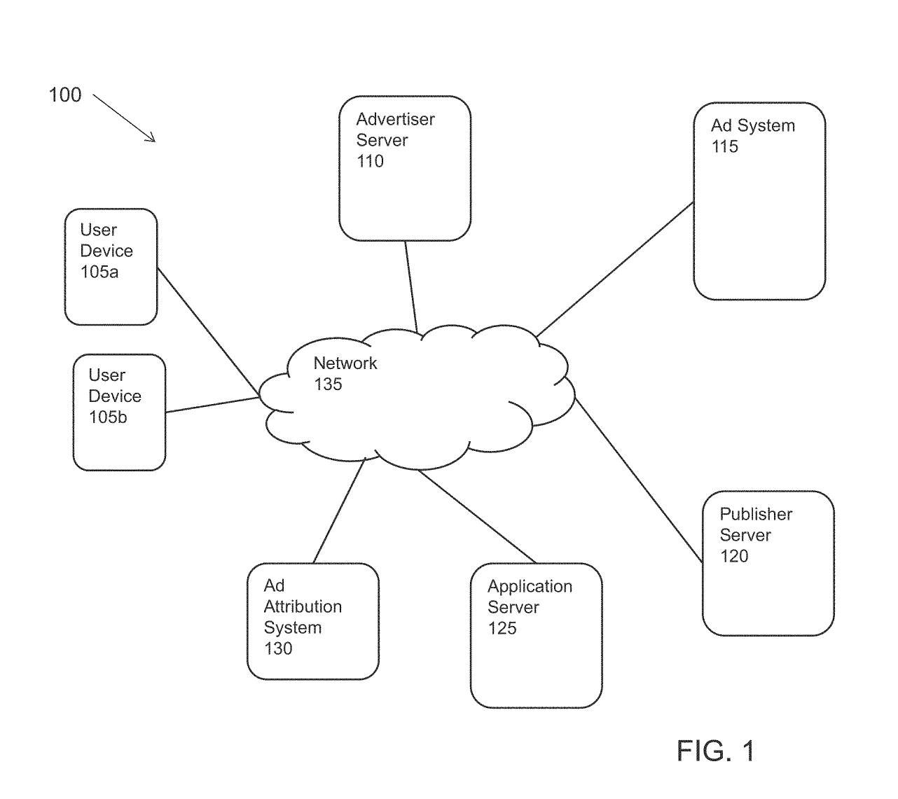

FIG. 1 is a diagram of a networked system 100 in accordance with embodiments of the technology. As illustrated, networked system 100 can include user devices 105, advertiser server 110, ad system 115, publisher server 120, application server 125, and ad attribution server 130. User devices 105, advertiser server 110, ad system 115, publisher server 120, application server 125, and ad attribution server 130 can be in data communication via network 135. User devices 105 can be any computing devices. In some embodiments, user devices 125 can be mobile computing devices (e.g., cellular phones and/or tablets). Advertiser server 110 can be any computing device, such as a server or multiple servers. In some embodiments, advertiser server 110 can store and/or serve advertising creatives relating to applications. Ad system 115 can be any computing device, such as a server or multiple servers. In some embodiments, ad system 115 can collect user behavior data for a plurality of users and generate user customization data based on the user behavior data. Publisher server 120 can be any computing device, such as a server or multiple servers. In some embodiments, publisher server 120 can serve webpages to user devices 105, such as webpages containing advertisements relating to applications. In some embodiments, publisher server 120 can serve other content to user devices 105, such as content that contains advertisements relating to applications for display in an application. Application server 125 can be any computing device, such as a server or multiple servers. In some embodiments, application server 120 can store and/or serve application installation packages. Ad attribution system 130 can be any computing device, such as a server or multiple servers. Ad attribution system 130 can track interaction by user devices 105 with ads on webpages, such as when user devices 105 download and/or install applications in response to ads on webpages. Network 135 can be any network or multiple networks. For example, network 135 can include cellular networks through which user devices 105 are connected and the Internet.

### Methods for Customizing Applications

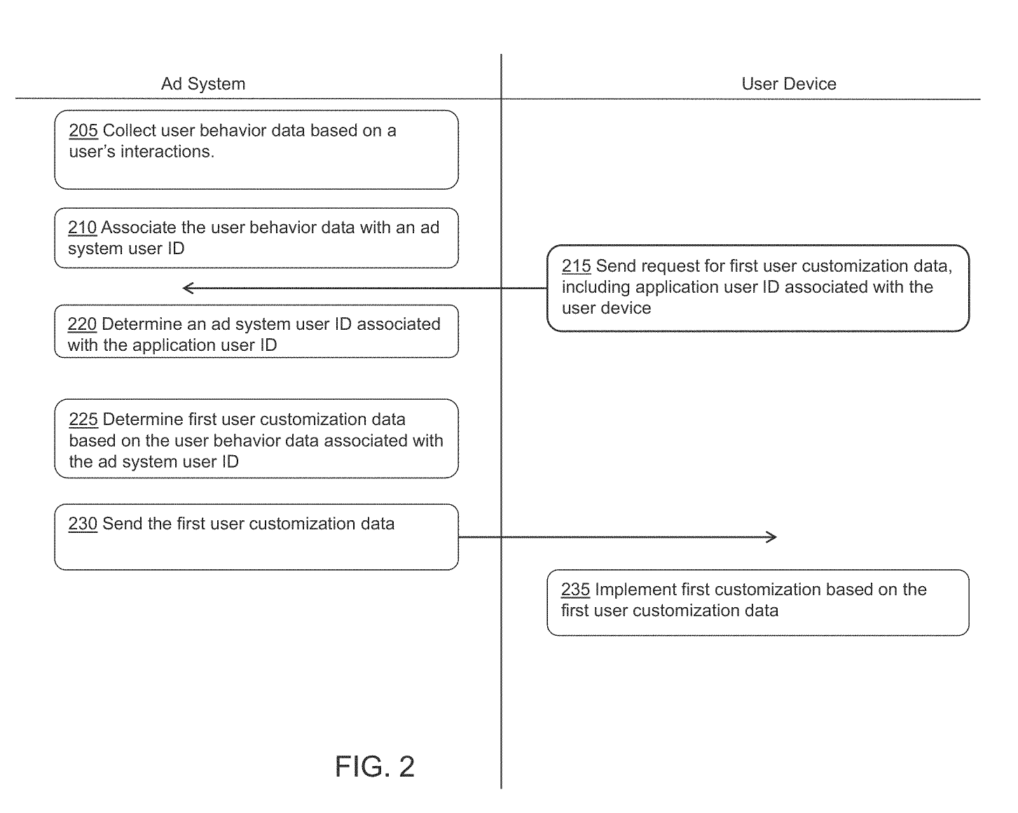

FIG. 2 depicts a flow chart of a method for customizing an application. At step 205, an ad system can collect user behavior data based on a user's interactions. In some embodiments, the user's interactions can include the user's browsing interactions with one or more websites. For example, the user behavior data can relate to the user's visiting webpages on the one or more websites, purchasing items from the websites, or other information relevant to the user's preferences. The ad system can collect the user behavior based on the user's interactions with the one or more websites from a variety of computing devices, such as desktop computers running a browser, mobile devices running a browser, etc. In some embodiments, the user's interactions can include the user's interactions with one or more applications. At step 210, the ad system associates the user behavior data with an ad system user ID. In some embodiments, the ad system user ID can be a unique identifier, such as a number or alphanumeric string, assigned to the user by the ad system. In some embodiments, the ad system user ID can be the same as an application user ID.

At step 215, a first application executing on a user device can send a first request for first user customization data to the ad system. The first request can include an application user ID that is associated with the user device. The application user ID can be an identifier associated with the user device, such as the user device's Identifier for IDFA or ANDROID Advertising ID.

At step 220, the ad system determines an ad system user ID associated with the application user ID. In some embodiments, the ad system user ID can be different from the application user ID. The ad system can determine the ad system user ID associated with the application user ID based on a stored association determined during prior interactions with the user device or other information determined from the user device. At step 225, the ad system determines first user customization data based on the user behavior data associated with the ad system user ID. Beneficially, the user behavior data can include behavior data from the user's interaction with websites from multiple devices or the user's interaction with applications from multiple devices, including other devices not associated with the application user ID. The first user customization can include data for customizing the first application. For example, the user customization data can include instructions for displaying specific content, as determined based on the user behavior data. The user customization data can include information about one or more products the user may be interested in based on the user behavior data. The user customization data can include instructions to cause the first application to deep-link as specified in the first user customization data. The user customization data can include settings or instructions for configuring the application based on the first user customization data.

At step 230, the ad system sends the first user customization data to the user device. At step 235, the first application executing on the user device implements a first customization based on the first user customization data. For example, the first customization can include the first application displaying content indicated by the first user customization data, such as one or more of a merchant's products. The first customization can include the first application deep-linking as specified in the first user customization data. The first customization can include the first application applying a configuration specified in the first user customization data.

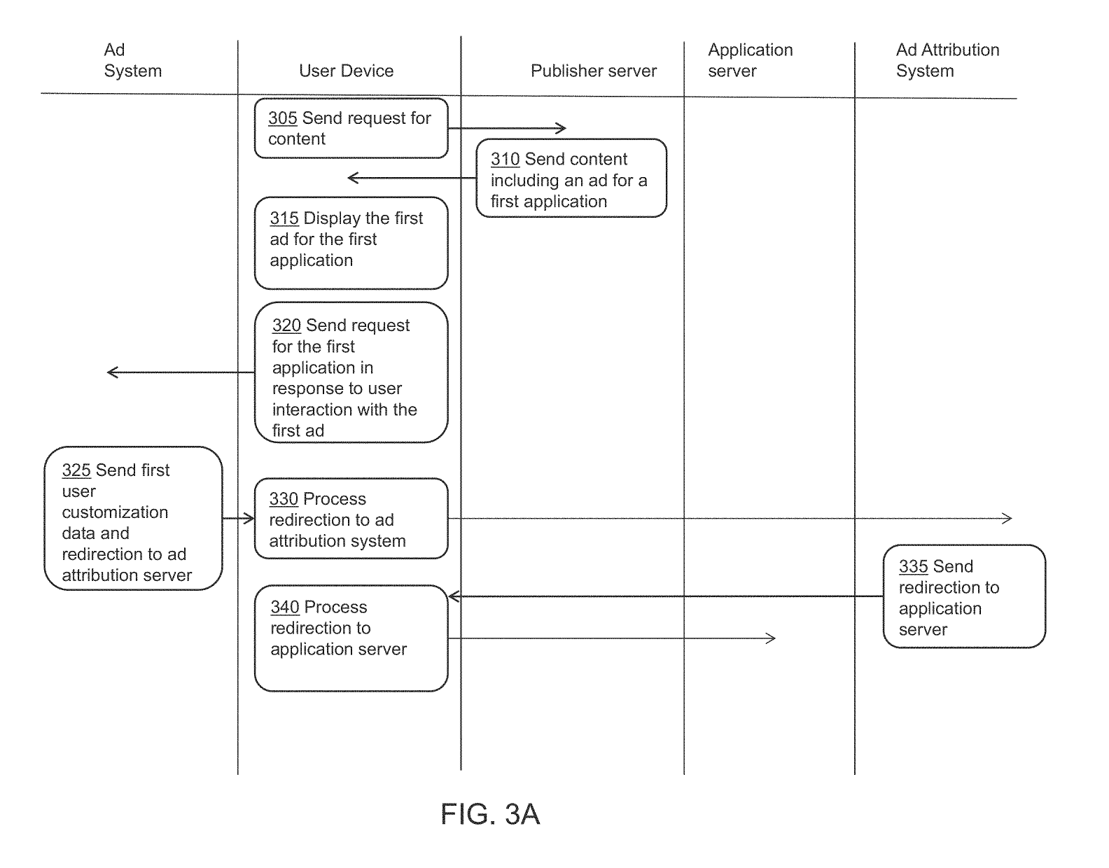

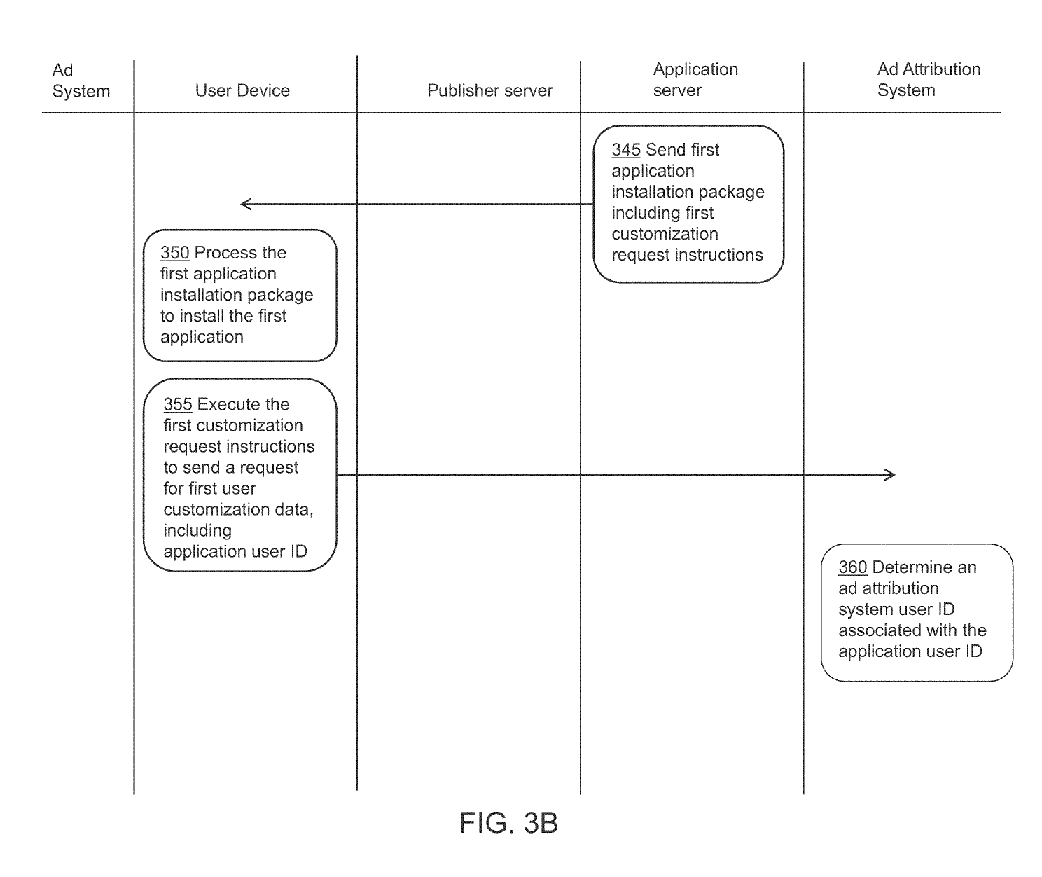

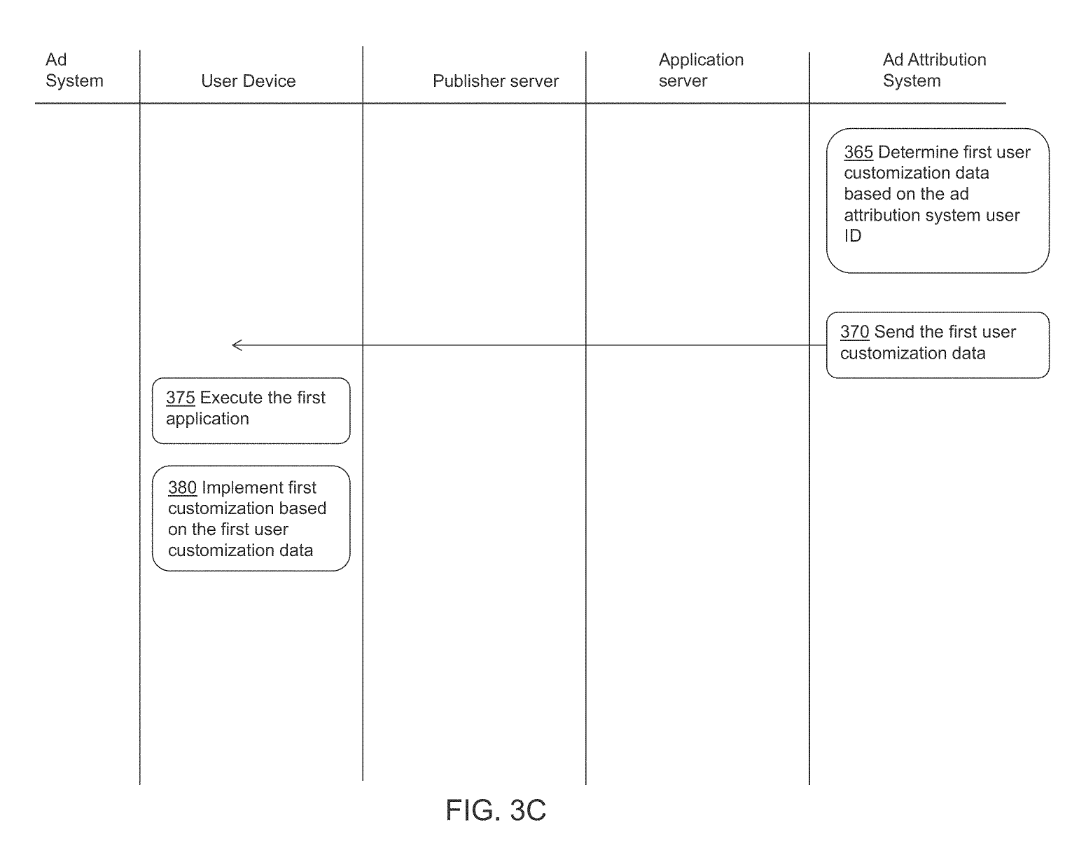

In some embodiments, the technology can facilitate customizing an application when the application is first installed. FIGS. 3A-3C depict a flow chart of a method for customizing an application at the time of installation. As described above, an ad system can collect user behavior data based on a user's interactions with one or more websites and/or one or more applications. The user behavior data can be utilized for application customization as illustrated in FIGS. 3A-3C. At step 305, a user device can send a first request for content to a publisher server. The content can be a webpage or an application page. At step 310, the publisher server can send the content to the user device. The content can include a first ad for a first application. In some embodiments, the first ad can be served by the publisher server. In some embodiments, the first ad can be served by an ad system or an advertiser server. At step 315, the user device can display the first ad for the first application. In some embodiments, the user device can process the content received from the publisher server to display the first ad, which can include making one or more requests to an advertiser server or ad system to obtain the components of the first ad.

At step 320, the user device can send a request for the first application in response to user interaction with the first ad. In some embodiments, the request for the first application can be sent in response to a user clicking on the first ad or otherwise providing user input to the user device indicating an intent to install the first application. In the illustrated embodiment, the user device sends the request for the first application to the ad system. The ad system can determine first user customization data based on user behavior data as described above. The ad system can send the first user customization data to an ad attribution system (e.g., by passing the first user customization data as parameters when redirecting the user device to the ad attribution system). At step 325, the ad system can send to the user device the first user customization data and a redirection to the ad attribution server. At step 330, the user device processes the redirection to the ad attribution system. In some embodiments, the ad system can pass the customization data to the user device as a part of the redirection URL. When processing the redirection, the user device can pass the user customization data to the ad attribution system. In some embodiments, the ad attribution system can store the customization data. In some embodiments, the ad attribution system can store the customization data as associated with an ad attribution system user ID.

At step 335, the ad attribution system can send to the user device a redirection to an application server. At step 340, the user device can process the redirection to the application server. At step 345, the application server can send a first application installation package. The first installation package can include first customization request instructions that can cause the user device to request user customization data when the first application is installed. At step 350, the user device can process the first application installation package to install the first application. At step 355, the user device can execute the first customization request instructions to send a request to the ad attribution system for the first user customization data. The request can include the application user ID.

At step 360, the ad attribution system can determine an ad attribution system user ID associated with the application user ID. At step 365, the ad attribution system can determine first user customization data based on the ad attribution system user ID. For example, the ad attribution system can retrieve the first user customization data stored as associated with the ad attribution system user ID. At step 370, the ad attribution system can send the first user customization data to the user device. At step 375, the user device can execute the first application. At step 380, the first application running on the user device implements a first customization based on the first user customization data.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The technology has been described in terms of particular embodiments. The alternatives described herein are examples for illustration only and not to limit the alternatives in any way. The steps of the technology can be performed in a different order and still achieve desirable results. Other embodiments are within the scope of the following claims.

What is claimed is:

1. A method performed by a computing system comprising:
collecting and storing, by an ad system, user behavior data based on a user's interactions;
associating, by the ad system, the user behavior data with an ad system user ID;
sending, by a first application executing on a user device, a first request for first user customization data, the first request comprising an application user ID associated with the user device;
receiving, by the ad system, the first request for the first user customization data;
determining, by the ad system, the ad system user ID is associated with the application user ID;
determining, by the ad system, the first user customization data based on the user behavior data stored by the ad system as associated with the ad system user ID;
sending, by the ad system, to the user device, the first user customization data; and
implementing, by the first application executing on the user device, a first customization based on the first user customization data.

2. The method of claim 1, wherein the first customization comprises the first application displaying content indicated by the first user customization data.

3. The method of claim 2, wherein the first application is associated with a merchant and the first customization comprises the first application displaying one or more of the merchant's products indicated by the first user customization data.

4. The method of claim 1, wherein implementing the first customization, by the first application executing on the user device, comprises causing the first application to deep-link as specified in the first user customization data.

5. The method of claim 1, wherein the first customization comprises configuring the first application based on the first user customization data.

6. The method of claim 1, wherein the ad system user ID is the same as the application user ID.

7. The method of claim 1, wherein the user's interactions comprise the user's browsing interactions with one or more websites.

8. The method of claim 1, wherein the user's interactions comprise the user's interactions with one or more applications.

9. A method performed by a computing system comprising:
receiving, by a user device, a first ad for a first application;
displaying, by the user device, the first ad for the first application;
sending, by the user device, to the ad system, a first request for the first application in response to a user interaction with the first ad;
sending, by the ad system, first user customization data to an ad attribution system;
redirecting, by the ad attribution system, the user device to an application server;
receiving, by the user device, from the application server, a first application installation package for the first application, the first application installation package comprising first customization request instructions;
processing, by the user device, the first application installation package to install the first application;
executing, by the user device, the first customization request instructions to send a second request for first user customization data, the second request comprising the application user ID associated with the user device;
receiving, by the ad attribution system, the second request for the first user customization data;
determining, by the ad attribution system, an ad attribution system user ID associated with the application user ID;
determining, by the ad attribution system, the first user customization data based on the ad attribution system user ID;
sending, by the ad attribution system, to the user device, the first user customization data;
executing, by the user device, the first application; and
implementing, by the first application, a first customization based on the first user customization data.

10. The method of claim 9, further comprising determining, by the user device, that the first application is not installed on the user device prior to sending the first request.

11. The method of claim 9, wherein the first customization comprises the first application displaying content indicated by the first user customization data.

12. The method of claim 11, wherein the first application is associated with a merchant and the first customization comprises the first application displaying one or more of the merchant's products indicated by the first user customization data.

13. The method of claim 9, wherein implementing the first customization, by the first application, comprises causing the first application to deep-link as specified in the first user customization data.

14. The method of claim 9, wherein the first customization comprises configuring the first application based on the first user customization data.

15. The method of claim 9, wherein the ad attribution system user ID is the same as the application user ID.
